(19) United States
(12) Patent Application Publication
(10) Pub. No.: US 2007/0181204 A1
(43) Pub. Date: Aug. 9, 2007

(54) INSULATED DUAL WALL DUCT

(76) Inventor: William K. Stout, Maineville, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/671,653

(22) Filed: Feb. 6, 2007

Related U.S. Application Data
(60) Provisional application No. 60/765,584, filed on Feb. 6, 2006.

(51) Int. Cl. F16L 9/14

(52) U.S. Cl. 138/149; 138/109; 138/155

(57) ABSTRACT

An insulated duct. The duct includes a concentric arrangement of a flowpath-defining inner wall and an outer wall, with insulation disposed in the annular region between the walls. A portion of the axial length of the annular region away from the end of the duct is filled with lower-density insulation, while another portion adjacent the duct end is filled with higher-density insulation than that of the portion away from the duct end. The higher-density insulation helps keep the concentric walls in their as-manufactured relative spacing and shape. Flanges may be attached to one or both of the walls at the ends of the duct to facilitate joining of adjacent duct segments.

This application claims the benefit of U.S. Provisional Application Ser. No. 60/765,584, filed Feb. 6, 2006.

### BACKGROUND OF THE INVENTION

The present invention is generally related to ducts, plenums or related fluid-handling system componentry, and more particularly to flanged ducts with dual-wall, insulative features.

Heating, ventilating and air conditioning (HVAC) systems typically include a network of duct components to provide appropriate air flow for residential, commercial, industrial and related building structures. Connectivity between adjoining duct components is usually established via either a male-female slip-fit or by fastening together mating flanges, the latter typically through clips, threaded nut-and-bolt arrangements or related fasteners. A layer of insulative material can be used as an internal liner for sheet metal (or related thin-walled) ductwork for HVAC applications. Such liners help to maintain the temperature of the fluid passing through the duct and, during cooling operations, prevent condensation on exterior surfaces of the duct. Thermally insulative material (for example, foam, fiberglass, rock wool or related material) can also can provide efficient sound absorption to control noise transmission within or around ductwork.

It is undesirable for layers of insulation to be in direct contact with high throughflow air, as portions of the relatively frangible insulation material can break off into the flowpath and become airborne. In addition to reducing the effectiveness of the remaining liner material, the dislodged material can be conveyed to people being served by the HVAC system, eventually posing respiratory or other risks. In response, one particularly popular duct construction involves the use of double-walled pipe, where concentric shells (also called tubes) separated by the insulating layer are useful in providing both enhanced levels of thermal and acoustic insulation as well as protecting the relatively fragile insulation against the ravages of moving air. In such construction, the inner tube is often perforated to promote acoustic coupling of the flowing fluid source to the insulative material.

To ensure the fluid-bearing integrity of joined duct components, it is generally necessary to substantially align both the inner and outer tubes of a double-walled duct to their respective counterparts in an adjoining duct. This in turn requires a greater attention to detail during installation than with single-walled ducts, as both the inner and outer tubes must be properly aligned to avoid poor fits that can lead to improper fluid migration. Accordingly, it is desirable during installation that the ends of the ducts retain as much of their original shape as possible. Generally cylindrical duct, for example, should be kept as close to round as possible, as eccentricities in its shape (due to manufacturing tolerances and mishandling, among others) make the installation process more laborious, as well as jeopardize the ability of the duct to properly carry out its fluid-transport function. Similar deviations from manufactured oval or rectangular ducts should also be avoided. Difficulties in keeping the ends of the ducts in their as manufactured shape are especially acute when adjacent duct segments are connected through a male/female or related slip-fit, as in essence four tubes with relatively unsupported ends must be joined to ensure a secure, gap-free connection. This difficulty is exacerbated when the ends include seals, gaskets or related leakage-inhibiting devices.

One way to avoid end deformities associated with slip-fit connections is through the use of flanges. With cylindrical and oval flanged duct, the flange is attached at the free end of the duct, and by virtue of its relatively thick ring-like structure, possesses significant hoop strength and concomitant resistance to radial deformation. In configurations where the duct is a double-walled duct, the flange can be attached at the free end of the outer tube. Such an arrangement, while beneficial for the outer tube, does little in the way of ensuring radial rigidity of the fluid-bearing inner tube. A set of separate inner and outer flanges can be joined together, but involve significant increases in weight, duct cost and assembly time. Similarly, an internal flange (i.e., a flange for the relatively thin-walled inner tubes of a double-walled duct) may provide adequate resistance to deformation of both tubes (especially if used in conjunction with a flange on the outer tube, including an integral flange that bridges both tubes), but is prone to leakage, as joined areas (for example, the outer tube)are unsupported. What sealant (for example, caulk) such joined areas may possess is easily pulled apart if an outer tube becomes dented, moved or is otherwise disturbed. Attempts to overcome this by welding are often unsuccessful, as the relatively thin-gauge metal of the inner tube is susceptible to damage during the welding process.

Another way to minimize the likelihood of end deformations while still employing a slip-fit connection is through the use of spacers (sometimes referred to as Z-bars). Their development is an attempt to minimize the likelihood of inadvertent shape changes to duct componentry, while avoiding the weight and manufacturing cost of multiple or integral flanges. In such a configuration, shaped spacers are affixed, such as by welding, to both the outer wall of the inner tube and the inner wall of the outer tube, thereby increasing the overall radial stiffness of the entire duct. While spacers are generally beneficial in preserving the manufactured duct shape prior to joining with an adjoining piece, the process of inserting and securing spacers can contribute significantly to duct manufacturing costs. Moreover, the overlap inherent in slip-fit segments necessitates that the spacers be longitudinally offset such that they do not extend all the way to the end of each duct, to interfere with the slip-fit. Such axial offset negates some of the shape-retention attributes of the spacers. In addition, spacer connection forms but a small contact area between the inner and outer tubes, and is therefore still of limited benefit against a point load that doesn't happen to coincide with the contact area between the spacer and the duct to which it is attached.

In still another variant, a duct can include both an outer duct flange and an inner duct slip-fit. While such a configuration does not suffer the weight penalty of having both an inner duct flange and an outer duct flange (or an integral flange large enough to support both), it still requires some form of supplemental support for the easily-deformable inner duct, thus making installation difficult with the inner duct slip-fit connection. As such, it still suffers from one or more of the aforementioned shortcomings.

What is needed is a way to provide protection of the free end of double-walled duct against mishandling or other events that can otherwise cause one or more of the duct tubes to become deformed away from their as-manufactured shape. What is additionally needed is an end configuration that avoids the dimensional uncertainty and sealing difficulty associated with slip-fit connections. What is further needed is a duct configuration that achieves enhanced levels of dimensional consistency without the significant weight associated with multiple-flanged construction, and without sacrificing thermal or acoustic insulation capabilities.

### SUMMARY OF THE INVENTION

The present invention overcomes the various disadvantages of the prior art. Improved shape retention is made possible by the present invention and enables the duct to be easily installed in a variety of configurations while being rigid, insulated and lightweight. In accordance with one aspect of the present invention, an air duct assembly includes an inner wall surrounded by an outer wall, with insulation positioned in an annular plenum formed between the outer and inner walls. A flange is attached to the outer wall to enable adjoining duct elements to be connected together through the flange. In the present context, a duct (or a duct element) is generally referred to as one component of a larger duct assembly or system, where it is understood that numerous such elements connected together define the air duct assembly to deliver air or related fluids to desired locations in or about a particular structure. The distinction between the term “duct” being used to describe a single duct element and numerous such elements pieced together to form a portion or complete duct assembly will be apparent from the context. Likewise, the alternate terms “wall” and “walls” or “shell” and “shells” can be used to refer to the inner and outer tubular members making up the present duct and duct assembly.

The insulation employed in the annular region between the inner and outer walls has various properties over its length. A first, lower-density portion is used along at least a portion of the length of the duct element that is not at or near the duct element free end, while a second, higher-density portion is used in the vicinity of the free end of the duct element. The second portion is possessive of a flexural rigidity sufficient to resist deformation that otherwise might occur during normally-encountered installation procedures. Similarly, the rigidity of the second insulation portion is such that the as-manufactured spacing and shape between the inner and outer walls remains relatively constant, thereby improving its ability to resist deformation while being handled and transported prior to assembly. The additional resistance to deformation made possible by the inclusion of relatively rigid second insulation makes it possible to eliminate the inner flange or an inner slip connection with the outer flange, while the higher weight and cost of the second portion means that its use is preferably limited to the vicinity of the free end of each duct element. It will be appreciated by those skilled in the art that what constitutes the vicinity of the free end (also referred to as duct end) is dependent upon numerous factors, including duct wall thickness, duct diameter, duct material, that portion of the duct which is subject to deforming forces during connection, or the like. In the present context, the free end generally corresponds to the portion of the duct element that is adjacent an opening to which an additional duct element or duct termination can be attached. Thus, it may extend as far as one diameter along the axial dimension of the duct. In one form, the various insulation portions may correspond to discrete segments that may be manufactured separately, then joined together. In another, the various insulation portions may be formed from a single piece of insulation material that has its structural, acoustic or related properties vary along its length.

The inner wall can be perforated (leading to, for example, up to approximately twenty five percent open space on the surface of the inner wall) to facilitate acoustic coupling between a fluid passing through the duct and the insulation disposed in the annular plenum between the two concentric walls. Moreover, the inner wall may be made from relatively wide, plate-like members formed into tubular shapes, or could be formed from relatively narrow spirally-wound sheets that include a lateral locking seam. In a preferred configuration, the perforations formed in the inner wall are of simple perforate construction rather than more complex shapes, such as expanded metal. Of course, the inner wall need not be perforate. For example, in situations where acoustical coupling is not critical, the inner wall may be solid.

The flange defines a plurality of fastener apertures formed therein such that upon alignment of the adjoining pair of the plurality of interconnected ducts, a fastener may be placed through the aperture to allowing fastening of the adjoining pair of the plurality of interconnected ducts. The first and second insulation portions are each formed from separate segments that are subsequently joined together to define a substantial whole. The second portion may extend axially into the annular region a certain distance. In one form, such extension may be up to approximately one duct diameter in length.

Preferably, the inner walls of the adjoining ducts do not overlap, instead butting up against one another. The relatively rigid positioning of the inner walls (which is made possible at least in part by the placement of the rigid insulation near the free end of the ducts) allows a substantially seamless joining of the two ducts. Furthermore, the structural rigidity of the second portion is enough to keep a substantially constant spacing between the inner and outer wall peripheries at least along the length of the duct that includes the more rigid second region. In this way, it protects against deformation or misalignment of the free end that may happen as a result of mishandling, dropping or related impact or other unforeseen circumstances. This is especially valuable for the inner wall, which does not have the benefit of the additional structural rigidity provided by the flange that is affixed to or part of the outer wall. In a preferred form, the second portion is the sole inter-wall connector in the part of annular region in which the second portion resides. In this way, other devices, such as the aforementioned Z-spacers, may be done away with. In another particular form, the second insulation portion is made up of a substantially rigid ring that is sized to fit within the annular region.

In accordance with another aspect of the present invention, an insulated double wall duct is disclosed. In one form, the duct includes an inner tubular wall that defines a fluid flowpath therein. The duct also includes an outer tubular wall concentrically arranged about the inner wall. Insulation is disposed in the annulus between the inner and outer walls, and includes a relatively high density portion adjacent the axial ends of the duct and a relatively low density portion axially between the high density portion. Flanges are attached at the ends of the duct. In one form, each flange is created by the connection of a reinforcing ring to the outer wall. This reinforcing ring, as well as the higher-density insulation, can be used to keep the relative position and spacing of the duct's concentric as-manufactured walls without having to rely on integral or multiple flanges, or on spacers or related supplemental annular reinforcing members.

In this aspect, each duct has opposing ends. The inner wall defines opposing free ends and a plurality of perforations along the length and around the periphery such that a significant portion of the surface of the inner wall is perforate. As like the inner wall, the outer wall defines opposing free ends. As with the previous embodiment, the free ends of the outer wall are substantially coextensive with respective free ends of the inner wall. A first insulation portion is situated along a length of the annular region that is generally away from the free ends, and is possessive of a first value of a thermal insulative capacity, acoustic insulative capacity or both. A second insulation portion is situated adjacent the free ends, and is more rigid than the first insulative portion. The increase in structural rigidity corresponds to a lower value of thermal and acoustic insulative capacities than that of the first insulation portion.

Optionally, the structural rigidity of the second insulation portion is such that no additional inter-wall coupling is used to maintain a substantially constant spacing between a substantial periphery of the inner and outer walls adjacent the free ends. In a preferred form, the second insulation portion is substantially rigid, while the first insulation portion is substantially non-rigid. As used herein, the terms “rigid” and “non-rigid” can be used both in a relative sense, as well as a more absoluter sense. In the latter, a rigid material (specifically, insulation), is that which is capable of substantially retaining its shape, even in the absence of a surrounding structure. Likewise, a rigid material will retain its shape even when only minimally or partially supported upon lifting. Contrarily, a non-rigid material is that which requires significant support, containment or backing in order to keep its shape. As regards insulation, closed-cell foam would be considered rigid, while bulk fiberglass, rock wool or the like would not.

In accordance with still another aspect of the present invention, a method of assembling a double wall duct is disclosed. The method includes bringing two the ducts into engagement with one another. Flanges formed on or affixed to the duct outer surfaces facilitates secure connection between the ducts. As discussed above, fasteners may be used to secure mating flanges to one another, as can welding or other joining methods known to those skilled in the art. In addition to bringing the ducts together, the method includes aligning the inner and outer walls of each of the ducts to their respective counterparts on the adjoining duct. Such aligning ensures that a fluid-conveying flow path is established by the adjacent inner walls. The inner walls are supported by a relatively rigid insulation disposed in an annular space formed between the inner and outer walls. In this way, the reinforcement provided by the rigid insulation layer means the spacing between the inner and outer walls remains substantially constant, even during transport and handling before and during the assembly, where accidental impact or other event may otherwise detrimentally cause deformation of the inner wall. The method also includes securing together the ducts that are brought into engagement with one another such that substantially leakage-free fluid communication is established between the joined ducts.

Optionally, all of the dimensions of the annular space between the inner and outer walls remains substantially constant during the assembly, so that not only does the spacing between the inner and outer walls remains constant, but the likelihood of any eccentricity forming in the inner wall is reduced. The method further comprises disposing a relatively non-rigid insulation into the annular space in the portion of the annular space that is not occupied by the relatively rigid insulation. Thus, the insulation used to fill the annular region between the inner and outer wall of the duct can include a relatively low-density insulation in axial portions that are away from ends of the duct, and a relatively high-density insulation in axial portions of the duct at or near the duct ends. Furthermore, perforations can be placed in the inner walls to promote acoustic performance.

### BRIEF DESCRIPTION OF THE SEVERAL VIEWS OF THE DRAWINGS

The following detailed description will be more fully understood in view of the drawing in which:

FIG. 1 is a perspective view of a slip-fit dual-walled duct element with spacers according to the prior art;

FIGS. 2A and 2B are side elevation views of a pair of dual-walled duct elements with an integral slip-fit placed at a free end of an inner wall of one of the ducts, where the duct elements are shown in both unjoined and joined states according to the prior art;

FIGS. 3A and 3B are side elevation views of a pair of dual-walled duct elements with a single outer wall flange on the outer wall of the elements in both unjoined and joined states, in addition to a slip-fit connection for the inner wall of each of the elements according to the prior art;

FIGS. 4A and 4B are side elevation views of a pair of dual-walled duct elements with multiple flanges placed at respective free ends of each of the inner wall and outer wall of the elements in both unjoined and joined states according to the prior art;

FIG. 5A is a side elevation view of two dual-walled duct elements joined together at flanges placed at respective free ends of an outer wall of the elements according to an embodiment of the present invention, the elements including a first insulation disposed between the inner and outer wall along a portion of the element and a second insulation disposed adjacent the joined ends;

FIG. 5B is a side elevation view of the two dual-walled duct elements of FIG. 3A while separated from one another;

FIG. 6 is a perspective view of a dual wall duct element having a circular shape with insulation disposed in an annular region between the inner and outer walls;

FIG. 7 is a perspective view of the dual wall duct element of FIG. 6, with a flange mounted to the free end of the outer duct wall; and

FIG. 8 is a rear perspective view of a flange that can be connected to an inner or outer wall.

### DETAILED DESCRIPTION

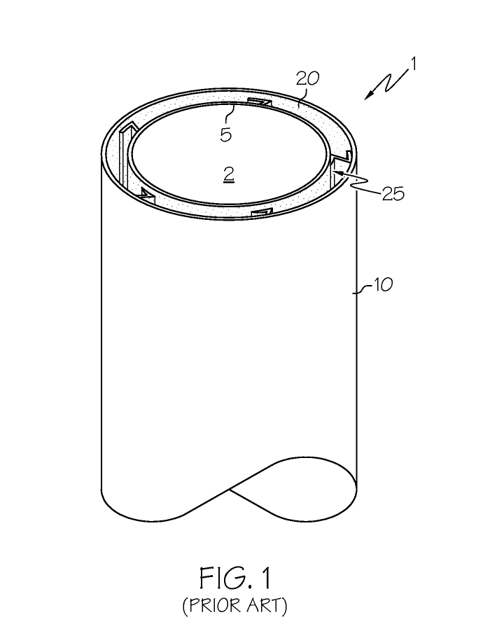

Referring first to FIGS. 1 through 4B, various forms of dual wall ducts 1 of the prior art are shown, where flow path 2 is used to convey a fluid, such as warmed or cooled air or other gases. Referring with particularity to FIG. 1, the inner wall 5 can be coupled to the outer wall 10 through a series of spacers (Z-bars) 25. While the spacers 25 establish connectivity and increase the rigidity between the inner and outer walls 5, 10, they also contribute to weight, fabrication complexity and cost. Moreover, they can provide an efficient transmission path for acoustic propagation through the duct 1 and into the surrounding environment. Insulation 20 may be disposed between the inner and outer walls 5, 10. In order to satisfy thermal, acoustic or other insulative needs, insulation 20 is of a preferably low-density material, such as bulk fiberglass, rock wool or the like.

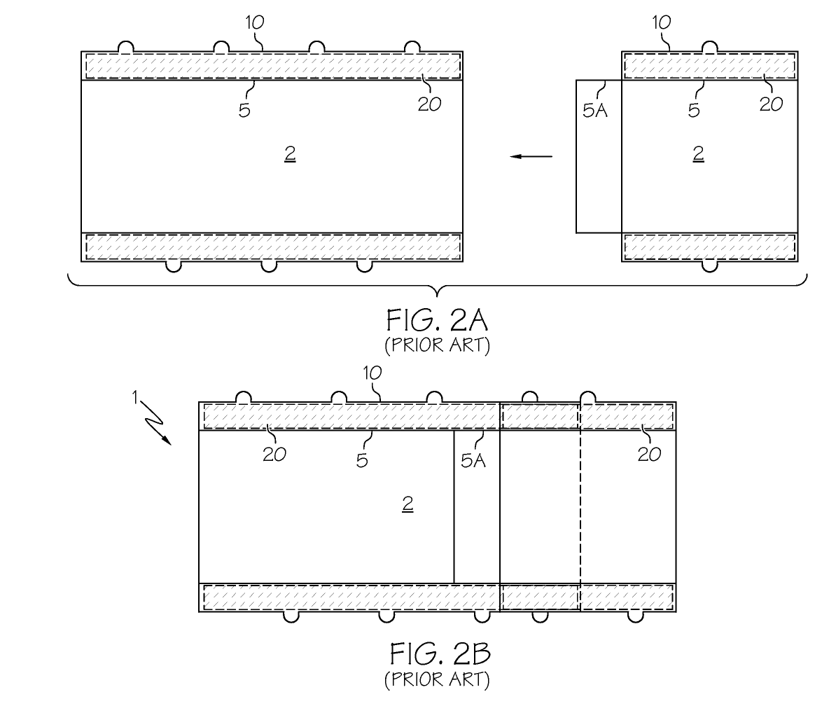

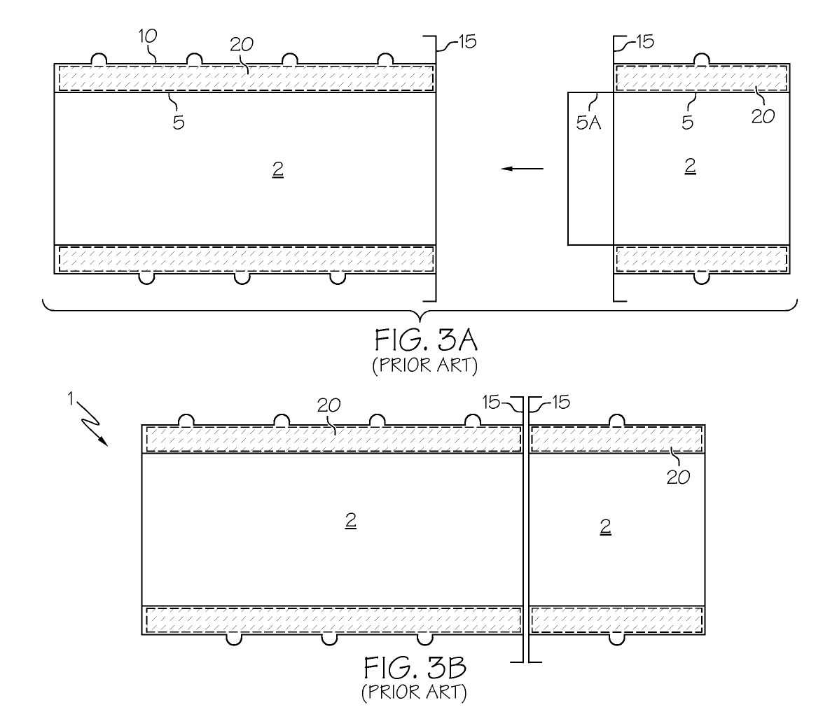

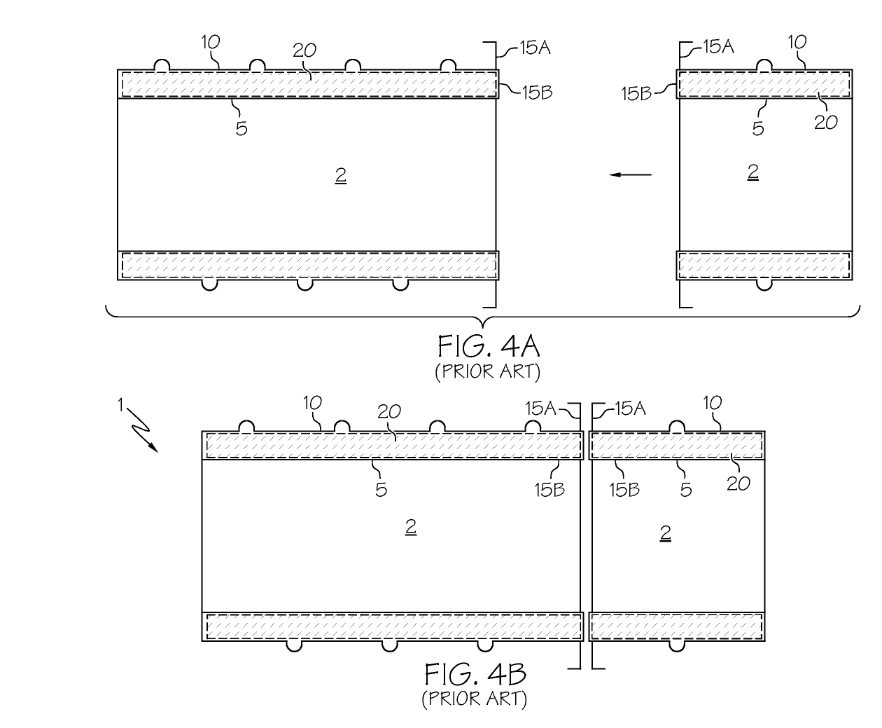

The connection of adjacent inner walls 5 can be through a slip-fit relationship, as shown in FIGS. 2A, 2B, 3A and 3B, or in an abutting relationship, as shown in FIGS. 4A and 4B. In the former configurations, the spacers 25 (shown only in FIG. 1) will need to be longitudinally (i.e., axially) offset to allow overlap of the joined inner walls 5. As shown with particularity in FIGS. 2A and 2B, two adjacent ducts 1 are placed together such that an axially projecting member 5A that extends from inner wall 5 from one of the ducts 1 can be slid into the other of the ducts 1 resulting in the friction fit shown in FIG. 2B. This joining occurs without the use of flanges. Referring with particularity to FIGS. 3A, 3B, 4A and 4B, two variations of flanged approaches are shown. In the variant depicted in FIGS. 3A and 3B, the projecting member 5A for slip-fit is coupled with a flange 15 that may be mounted to the free end of outer wall 10 of the duct 1. The slip-fit functions in a manner similar to that of FIGS. 2A and 2B, now with the extra outer wall stability provided by the adjacent flanges 15. In the variant depicted in FIGS. 4A and 4B, multiple flanges 15A (connected to the outer wall 10) and 15B (connected to the inner wall 5), may be used, while no slip-fit member is employed. In another version (not shown), flanges could be limited to the inner wall; however, as stated above, such an approach has shown susceptibility to leakage.

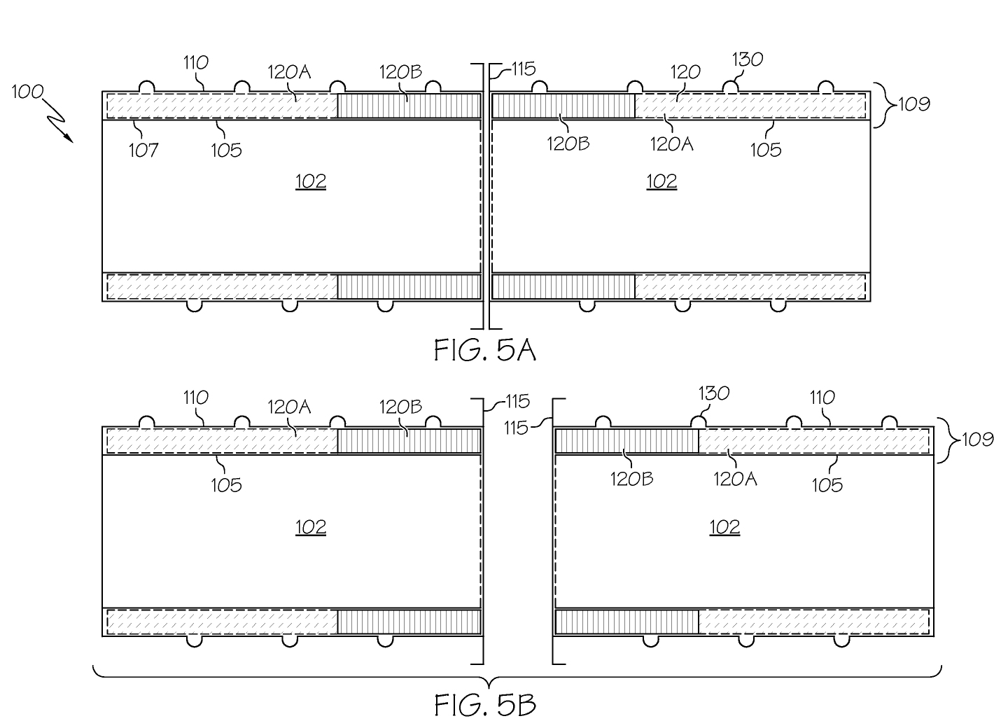

Referring next to FIGS. 5A and 5B, a dual wall duct embodiment 100 according to the present invention is shown. An inner wall (i.e., tube) 105 defines a flow path 102 therein, while an outer wall (i.e., tube) 110 is concentrically disposed about the inner wall 105 to provide dual walled construction. An annular region 109 is formed in the space between the inner wall 105 and the outer wall 110. A flange 115 is formed at the free end of the duct 100 at the outer wall 110, and can be used to connect adjoining pairs of ducts 100 as well as increase the rigidity of the outer wall 110. Seams 130 are a by-product of the spiral-winding process used to manufacture the outer wall 110, and are formed along its longitudinal (i.e., axial) dimension. Because of the nature of the insulation 120 (described below), a secure, relatively leak-free connection between joined segments of duct 100 is possible.

Insulation 120 is placed in the annular region 109, and is made up of first (low density) insulation 120A and a second (high density) insulation 120B. The first insulation 120A may be formed from a bat or other bulk form of conventional fibrous insulation, and because of its acoustically and thermally insulative properties, is preferably placed along the majority of the length of the duct 100. It will be appreciated by those skilled in the art that there may be circumstances or configurations where such a large portion of the length of the duct need not be insulated; in such cases, first insulation 120A may be confined to a more limited number of places commensurate with such needs.

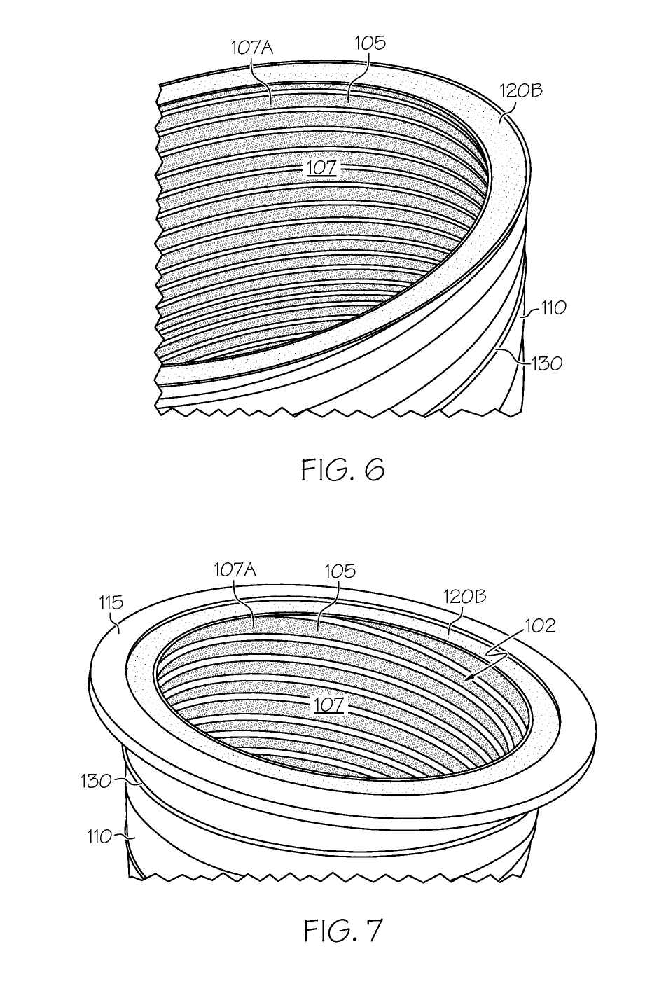

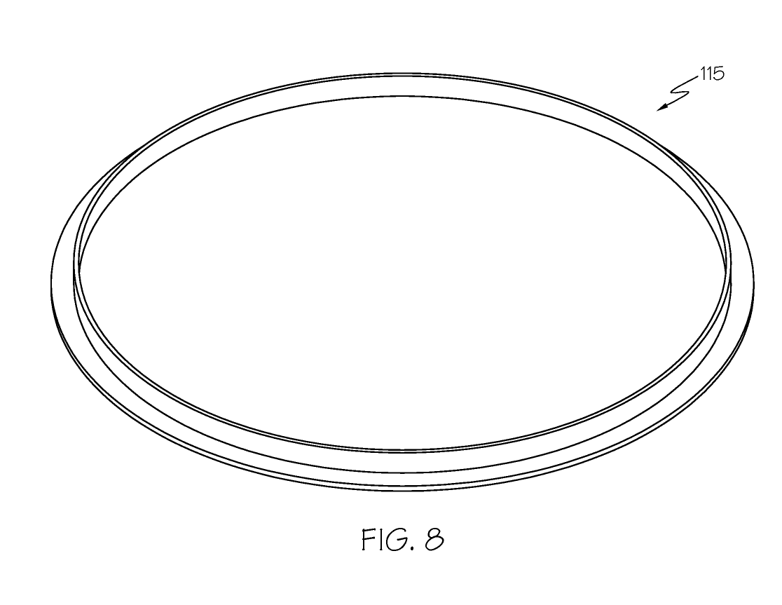

Referring next to FIGS. 6 through 8, a representation of the free end of duct 100 is shown. In FIG. 7, the end is shown with flange 115 in place. Flange 115 may be smooth (as shown), or may define numerous circumferentially-placed apertures (not shown) therein to facilitate the placement of bolts, screws, rivets or related fasteners therethrough. Outer wall 110 may be formed by a spiral wrapping technique, in which case seams 130 are in evidence. The internal flow path 102 is formed by the inner wall 105, and includes numerous perforations 107A on surface 107 of the inner wall 105. These perforations 107A allow acoustic and fluid coupling between the flow path 102 and the annular region 109. For example, such perforations may be used to provide acoustic enhancements (such as Helmholtz-like resonator cavities or the like). In FIG. 6, the flange has been removed to show the placement of insulation 120 between the inner and outer walls 105, 110. In particular, second insulation 120B with its relatively high load-bearing capability, is shown as being coextensive with the axial projections of the ends of the inner and outer walls 105, 110. The relatively rigid nature of second insulation 120B, coupled with the backing of the outer wall 110, gives the otherwise relatively deformation-prone inner wall 105 additional resistance against deformation due to handling, installation or the like. FIG. 8 shows a rearward view of flange 115, including the lip that is used to join the flange 115 to the outer wall 110. As stated before, flange 115 may have numerous apertures formed around its periphery for situations may call for bolted or similar connection between joined adjacent sections.

While certain representative embodiments and details have been shown for purposes of illustrating the invention, it will be apparent to those skilled in the art that various changes may be made without departing from the scope of the invention, which is defined in the appended claims. For example, it will be appreciated that in addition to the cylindrical-shaped ducts depicted in the present figures, other duct shapes are contemplated, including square, rectangular or oval configurations. Similarly, various duct lengths cross-sectional areas may enjoy the advantages of the present invention.

I claim:

1. An air duct assembly formed from a plurality of interconnected ducts, each of said ducts comprising:
an inner wall;
an outer wall disposed concentrically around said inner wall such that an annular region is defined therebetween;
a flange attached to said outer wall, said flange configured to allow an adjoining pair of said plurality of interconnected ducts to be secured to one another; and
insulation disposed in said annular region, said insulation comprising a first portion situated along a length of said annular region that is generally away from an end of said duct, and a second portion situated adjacent said end of said duct, said second portion comprising a greater amount of structural rigidity than said first portion.

2. The assembly of claim 1, wherein said flange formed is at an end of at least one of said ducts.

3. The assembly of claim 2, wherein said flange defines a plurality of fastener apertures formed therein such that upon alignment of said adjoining pair of said plurality of interconnected ducts, a fastener may be placed through said aperture to allowing fastening of said adjoining pair of said plurality of interconnected ducts.

4. The assembly of claim 1, wherein said first portion and said second portion are each formed from separate segments that are subsequently joined together to define a substantial entirety of said insulation.

5. The assembly of claim 1, wherein said inner wall defines a plurality of perforations therethrough.

6. The assembly of claim 5, wherein an aggregate area defined by said plurality of perforations comprises up to twenty five percent of the surface area of said inner wall.

7. The assembly of claim 1, wherein said second portion extends into said annular region up to approximately one duct diameter.

8. The assembly of claim 1, whereupon connection of said adjoining pair of said plurality of interconnected ducts, said inner wall of one of said adjoining pair of said plurality of interconnected ducts overlaps said inner wall of the other of said adjoining pair of said plurality of interconnected ducts.

9. The assembly of claim 1, wherein said structural rigidity of said second portion is such that a substantially constant spacing between a substantial entirety of the periphery of said inner and outer walls along a length of said duct that corresponds to said second portion is maintained.

10. The assembly of claim 1, wherein said second portion is the sole inter-wall connector in the part of annular region that corresponds to said second portion.

11. The assembly of claim 1, wherein said second portion comprises a substantially rigid ring that is sized to fit within said annular region.

12. An insulated double wall duct comprising:
an inner wall defining opposing free ends and a plurality of perforations therebetween;
an outer wall disposed concentrically around said inner wall such that an annular region is defined therebetween, said outer wall defining opposing free ends such that said opposing free ends of said outer wall are substantially coextensive with respective ones of said opposing free ends of said inner wall;
a flange attached to said outer wall, said flange configured to allow an adjoining pair of said ducts to be secured to one another;
a first insulation portion situated along a length of said annular region that is generally away from said free ends, said first insulation portion comprising a first value of at least one thermal insulative capacity and an acoustic insulative capacity; and
a second insulation portion situated adjacent said free ends, said second portion comprising a greater amount of structural rigidity than said first insulation portion, as well as a second value of at least one thermal insulative capacity and an acoustic insulative capacity, said second value lower than said first value.

13. The duct of claim 12, wherein said structural rigidity of said second insulation portion is such that no additional inter-wall coupling is used to maintain a substantially constant spacing between a substantial periphery of said inner and outer walls adjacent said free ends.

14. The duct of claim 12, wherein said second insulation portion is substantially rigid, and said first insulation portion is substantially non-rigid.

15. A method of assembling a double wall duct, said method comprising:
bringing two said ducts into engagement with one another, each of said ducts flanged on an outer surface thereof to promote secure connection therebetween;
aligning respective outer walls of each of said ducts along said flanges;
aligning respective inner walls of each of said ducts such that a fluid-conveying flow path is established, said inner walls supported by a relatively rigid insulation disposed in an annular space formed between said inner and outer walls such that spacing between said inner and outer walls remains substantially constant; and
securing together said plurality of ducts that are brought into engagement with one another such that substantially leakage-free fluid communication is established therebetween.

16. The method of claim 15, wherein dimensions of said annular space between said inner and outer walls remains substantially constant during said assembly.

17. The method of claim 15, further comprising disposing a relatively non-rigid insulation into said annular space in the portion of said annular space that is not occupied by said relatively rigid insulation.

18. The method of claim 15, further comprising forming a plurality of perforations in said inner walls.
